(19) United States
(12) Patent Application Publication
(10) Pub. No.: US 2004/0034620 A1
(43) Pub. Date: Feb. 19, 2004

(54) Interface apparatus for structured documents

(75) Inventor: Katsuhisa Kataoka, Sagamihara-shi (JP)

Correspondence Address: A. Bruce Clay, IBM Corporation, T81/503, PO Box 12195, Research Triangle Park, NC, 27709, US

(73) Assignee: International Business Machines Corporation, Armonk, NY

(21) Appl. No.: 10/632,178

(22) Filed: Jul. 31, 2003

(30) Foreign Application Priority Data
Jul. 31, 2002 (JP) 2002-222688

(51) Int. Cl. G06F 17/30

(52) U.S. Cl. 707/1

(57) ABSTRACT

An interface processes a structured document in response to a request concerning the document, and subsequently notifies an application program of a series of events relating to the document. The series of notified events are stored as event set information in a cache. When a processing request is received from the same or another application program, the event set information is read from the cache. The series of events relating to the structured document is reproduced based on the information, and the application program which has requested the structured document is notified of the series of reproduced events.

### TECHNICAL FIELD OF THE INVENTION

The present invention relates to an interface for a structured document, and more particularly to an interface for processing character code adjustment and lexical analysis in response to a request from an application program.

### BACKGROUND OF THE INVENTION

There has recently been an increased tendency to use an XML document to describe static information, such as constitution information, because XML documents are highly readable. Therefore, it is preferable for an application program to process an XML document in an interpreter format, that is, a Simple API for XML (SAX) format parser every time, allowing the SAX parser to analyze the XML document, and notify an event which is an analysis result from the SAX parser.

On receiving a processing request from the application program, the related-art SAX parser uniformly (a) reads the corresponding XML document, (b) adjusts a character code, (c) analyzes words and phrases, and (d) notifies the application program which has requested for the processing of a series of events.

An object of the present invention is to improve a processing rate in an interface apparatus for a structured document, method, and program for notifying an application program of a series of events corresponding to the structured document in response to a processing request from the application program concerning the structured document.

### SUMMARY OF THE INVENTION

In an interface for a structured document according to the present invention, a cache is used to store event set information (information of a series of events) notified to the application program into the cache. Moreover, there is a processing request from the application program which is the same as or different from the previous application program with respect to the structured document event set information stored in the cache. Based on the stored set, the series of events relating to the structured document are notified in order to the application program which is a processing requester at this time. In this manner, the same or another application program remakes the processing request to the interface apparatus for the structured document. Processing amount and time can largely be reduced. Moreover, since the stored event set information is not application-unique, only event notification to a specific application program cannot be applied, application of the event set information stored in the cache is enhanced.

The structured document includes a document whose content is classified in predetermined elements. Each element may also be hierarchical. That is, the structured document of the present invention includes structural and hierarchical documents. Examples of the structural and hierarchical documents include an XML document. Content of each element in the structured document is typically described in text. The structured document indicates each content corresponding to the element in a document structure and can also be grasped as a document structure defining document describing an element content. The structured document defines the document structure, for example, by a tag and element name.

The interface apparatus for the structured document processes lexical analysis and notifies the application program as the processing requester of the series of events relating to the structured document in order to be processed from the application program. The interface apparatus for the structured document comprises: store means for associating the series of events notified to the application program as event set information with the structured document to store the information into the cache; and first notification means for notifying the application program as the processing requester of the series of events relating to the structured document in order based on the event set information of the cache, when there is the event set information in the cache with respect to the structured document as a processing object.

The interface apparatus for the structured document according to the present invention comprises: first processing means for reading the structured document of a processing request object to perform the processing of the lexical analysis, the processing of notifying the application program as the processing requester of the series of events relating to the structured document in order, and the processing of associating the notified series of events as the event set information with the structured document to store the information into the cache; second processing means for reading the event set information of the cache with respect to the structured document of the processing request object to notify the application program as the processing requester of the series of events relating to the event set information in order; and control means for checking whether or not the event set information of the structured document of the processing object is in the cache to delegate the processing concerning the structured document of the processing object to the first processing means, when there is not the event set information in the cache, or to delegate the processing concerning the structured document of the processing object to the second processing means, when there is the event set information in the cache.

In a processing method for the structured document according to the present invention, processing of lexical analysis and processing of notifying an application program as a processing requester of a series of events relating to the structured document in order are performed with respect to the structured document requested to be processed from the application program. The processing method for the structured document comprises: a first step of associating the series of events notified to the application program as the event set information with the structured document to store the information into the cache; and a second step of notifying the application program as the processing requester of the series of events relating to the structured document in order based on the event set information of the cache, when there is the event set information in the cache with respect to the structured document of the processing object.

The processing method for the structured document according to the present invention comprises: a step for standard processing of reading the structured document of the processing request object to perform the processing of the lexical analysis, the processing of notifying the application program as the processing requester of the series of events relating to the structured document in order, and the processing of associating the notified series of events as the event set information with the structured document to store the information into the cache; a step for reduction processing of reading the event set information of the cache with respect to the structured document of the processing request object to notify the application program as the processing requester of the series of events relating to the event set information in order; and a control step of checking whether or not the event set information of the structured document of the processing object is in the cache, and controlling the step for the standard processing so as to be executed, when there is not the event set information in the cache, or controlling the step for the reduction processing so as to be executed, when there is the event set information in the cache.

### BRIEF DESCRIPTION OF THE DRAWINGS

The invention, as well as a preferred mode of use will best be understood by reference to the following Detailed Description when taken in conjunction with the accompanying Drawings, in which:

FIG. 1 is a diagram of a system in which an internet/intranet is used to obtain a structured document;

FIG. 2 is a diagram of an interface apparatus for a structured document according to a first embodiment of the present invention;

FIG. 3 is a flowchart of a processing procedure of the interface apparatus for the structured document of FIG. 2;

FIG. 4 is a diagram of an interface apparatus for a structured document according to a second embodiment of the present invention;

FIG. 5 is a flowchart of a processing procedure of the interface apparatus for the structured document of FIG. 4;

FIG. 6 is a diagram of the interface apparatus for the structured document according to a third embodiment of the present invention;

FIG. 7 is a flowchart of the processing procedure of the interface apparatus for the structured document of FIG. 6;

FIG. 8 is a flowchart of the processing procedure using event set information of a cache to update a structured document;

FIG. 9 is a diagram of a SAX parser which is the interface apparatus for the structured document;

FIG. 10 is a diagram showing a SAX event notified to an application program from a SAX event generation unit;

FIG. 11 shows a first part of SAX event set information to be recorded in the cache;

FIG. 12 shows a second part of the SAX event set information to be recorded in the cache;

FIG. 13 is a flowchart of the processing procedure of a parser for determining cache use of FIG. 9;

FIG. 14 is a flowchart of the processing procedure of a parser for generating the cache data of FIG. 9; and

FIG. 15 is a flowchart of the processing procedure of a parser for reproducing the cache data of FIG. 9.

### D TAILED DESCRIPTION OF THE INVENTION

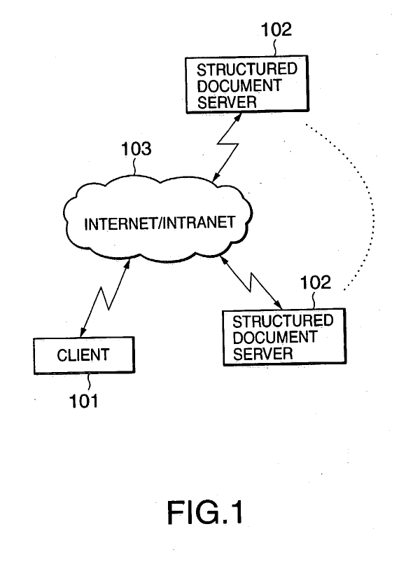

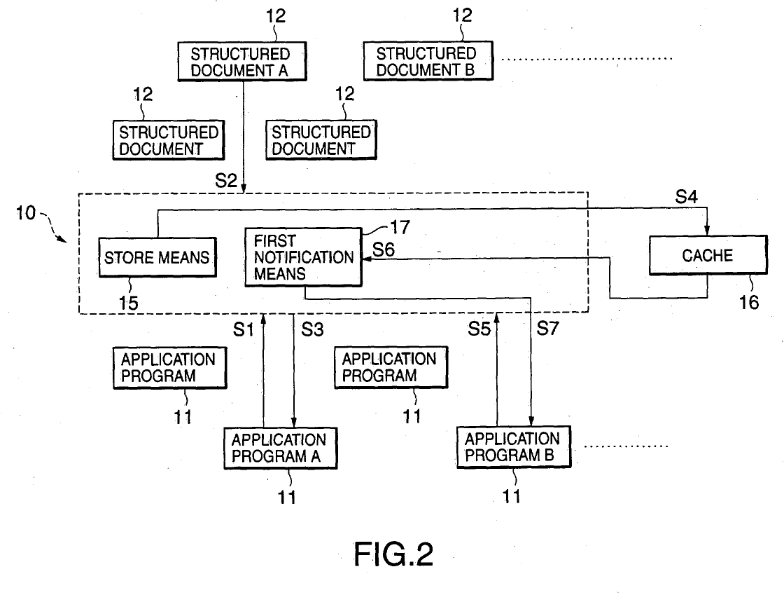

FIG. 1 is a diagram of a system in which an internet/intranet 103 is used to obtain a structured document. A client 101 is connected to a plurality of structured document servers 102 via the internet/intranet 103. For example, the client 101 has an interface apparatus for a structured document 10 together with application programs 11 using structured documents 12 (see FIG. 2), as described later. The client 101 designates a uniform resource locator (URL) and uses a hypertext delegate protocol (HTTP) to access the structured document server 102 managing the structured document 12 (FIG. 2) which is a processing object at this time, and obtains the desired structured document 12. It is to be noted that a computer including the application program and interface apparatus for the structured document has the structured document as the processing object in a local hard disk drive of the computer. Therefore, in this case, path and file names are used to obtain the structure document.

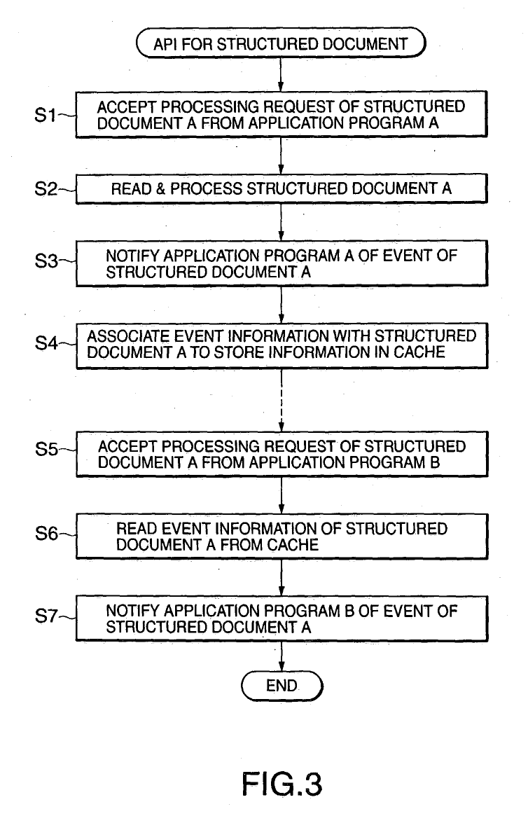

FIG. 2 is a block diagram of the interface apparatus for the structured document 10 according to a first embodiment of the present invention. In FIG. 2, S1 to S7 correspond to steps S1 to S7 of FIG. 3 described later. The interface apparatus for the structured document 10 accepts processing requests concerning various structured documents 12, 12, . . . from various application programs 11, 11, . . . The structured document 12 exists, for example, in the interface apparatus for the structured document 10 or application program 11 or in a predetermined folder of a storage unit of a server connected to the computer via LAN or internet. The structured document 12 may be a hierarchical structured document, and examples of the hierarchical structured document include an XML document. Examples of the application programs 11, 11, . . . include an application program for making a sound response based on the content of the structured document 12 in response to a phone inquiry, and an application program for making a guide screen based on the content of the structured document 12 in response to an operator's instruction. In the following, for the sake of convenience in description, the structured document 12 as the processing request object will be referred to as “structured document A”. The application program 11 which has first made the processing request concerning the structured document A to the interface apparatus for the structured document 10 will be referred to as “application program A”. The application program 11 which has made the processing request concerning the structured document A to the interface apparatus for the structured document 10 after the application program A will be referred to as “application program B”. Typically, the application program B is different from the application program A, but the application program B, in some case, may be the application program A. The interface apparatus for the structured document 10 includes store means 15 and first notification means 17, and appropriately uses a cache 16.

The interface apparatus for the structured document 10 responds to the processing request concerning the structured document A from the application program A (S1), reads the structured document A to perform character code adjustment and lexical analysis of the structured document A (S2), and notifies the application program A which is a processing requester at this time of the series of events relating to the structured document A in order (S3). It is to be noted that the character code adjustment is conversion, for example, to Unicode from Shift JIS, when the structured document is a Japanese XML document. Conventional XML parsers convert and process the XML document into Unicode. Conventional interface apparatuses for the structured documents perform both the character code adjustment and lexical analysis of the structured document A. However, some of the interface apparatuses for the structured documents may omit the character code adjustment of the structured document A, and immediately perform the lexical analysis of the structured document A. The store means 15 of the interface apparatus for the structured document 10 associates the series of events notified to the application program A as the event set information with the structured document A to store the information in the cache 16 (S4). It is to be noted that storing of event set information into cache 16 is stopped when an error is found in the lexical analysis. Therefore, when there is even one error of the lexical analysis in the structured document A, the event set information is not stored into the cache 16 with respect to the structured document A. An example of an error includes having a start element name tag, but having no end tag. When the structured document is, for example, an XML document, the error in the lexical analysis is as defined in Recommendation of XML1.0 (1.0 denotes a version at filing time of the present application) of World Wide Web Consortium (W3C). All errors against XML rules defined in the specifications of XML1.0 are included in the errors in the lexical analysis. Next, it is assumed that the application program B has issued the processing request to the interface apparatus for the structured document 10 with respect to the structured document A (S5). The first notification means 17 of the interface apparatus for the structured document 10 does not repeat the whole processing at a time when the application program A issues the processing request with respect to the structured document A. Concretely, without performing the processing of again reading the structured document A to again perform the character code adjustment and lexical analysis of the application program A, the means reads the event set information stored in the cache 16 with respect to the structured document A (S6), detects the series of events based on the read event set information, and notifies the application program B of the series of events in order (S7).

FIG. 3 is a flowchart of a processing procedure of the interface apparatus for the structured document 10 of FIG. 2. The interface apparatus for the structured document 10 fulfils a function of a structured document application program interface (API) with respect to the application program 11. In S1, the processing request concerning the structured document A is accepted from the application program A. In S2, the structured document A is read. In the processing request concerning the structured document A from the application program A, the structured document A is specified with the path name (when the structured document A is a local file) or URL (when the structured document A is obtained via the network). The structured document A is read directly by the computer including the interface apparatus for the structured document 10 (when the structured document A is specified by the path name) or via HTTP (when the structured document A is specified by URL). In S3, the application program A is notified of the series of events relating to the structured document A in order. In S4, the series of events notified in S3 are associated as the event set information with the structured document A and stored in the cache 16. In S5, the processing request concerning the structured document A is accepted from the application program B. In S6, the event set information on the application program A in the cache 16 is read. In S7, the series of events are detected based on the read event set information, and the respective events are notified to the application program B in order.

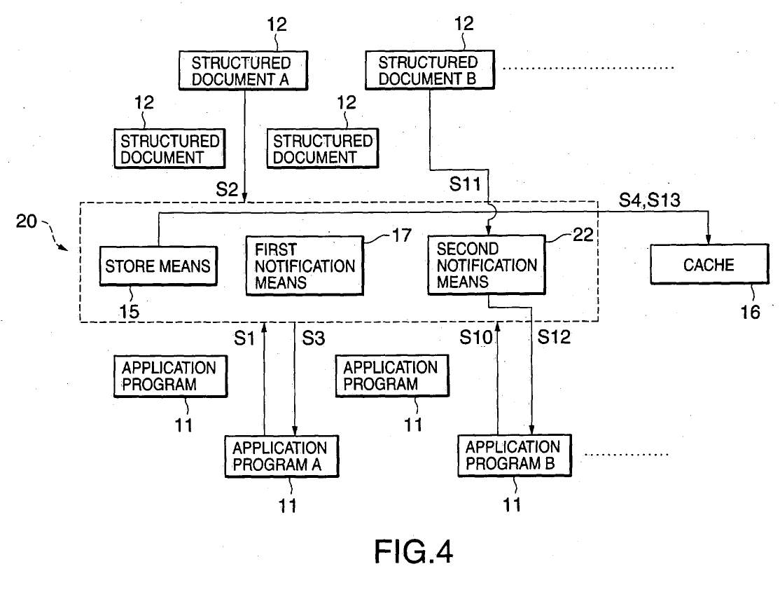

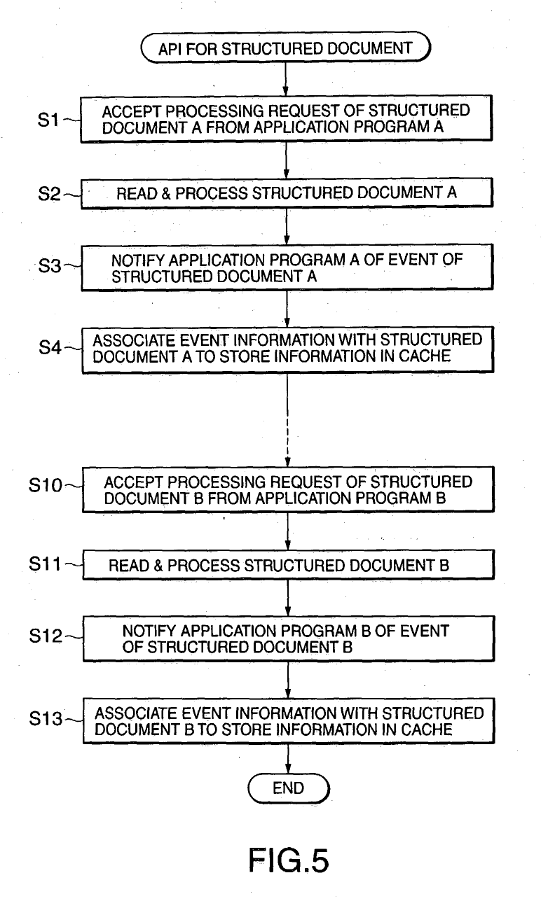

FIG. 4 is a function block diagram of the interface apparatus for the structured document 20 according to a second embodiment of the present invention. In FIG. 4, S1 to S13 correspond to steps S1 to S13 of FIG. 5 described later. For the interface apparatus for the structured document 20, the description of the same components as those of the interface apparatus for the structured document 10 is omitted, and different respects from the interface apparatus for the structured document 10 will be described. In the interface apparatus for the structured document 20, second notification means 22 is added to the interface apparatus for the structured document 10. Here, the following is assumed. In the assumption, the event set information of the structured document A is stored in the cache 16, but the event set information of the structured document B as a structured document different from the structured document A is not stored. Furthermore, in this state, it is assumed that the application program B requests the interface apparatus for the structured document 20 to process the structured document B (S10). The second notification means 22 reads the structured document B to perform the character code adjustment and lexical analysis (S11). Thereafter, when there is not the error in the words and phrases, the application program B is notified of the series of events concerning the structured document B in order (S12). On the other hand, in the same manner as when the interface apparatus for the structured document 10 (FIG. 2) stores the event set information on the structured document A into the cache 16, the store means 15 associates the series of events notified to the application program B as the event set information with the structured document B to store the information in the cache 16 (S13).

FIG. 5 is a flowchart of the processing procedure of the interface apparatus for the structured document 20 of FIG. 4. In FIG. 5, since S1 to S4 are the same as S1 to S4 of FIG. 3, the description thereof is omitted, and only S10 to S13 will be described. S10 to S13 are the steps for the structured document B, whereas the steps S1 to S4 are for the structured document A. The contents correspond to S1 to S4. In S10, the processing request concerning the structured document B is accepted from the application program B. In S11, the structured document B is read. In the processing request concerning the structured document B from the application program B, in the same manner as in the structured document A, the structured document B is specified by the path name or URL. In S12, the application program B is notified of the series of events relating to the structured document B in order. In S13, the series of events notified in S12 are associated as the event set information with the structured document B and stored in the cache 16.

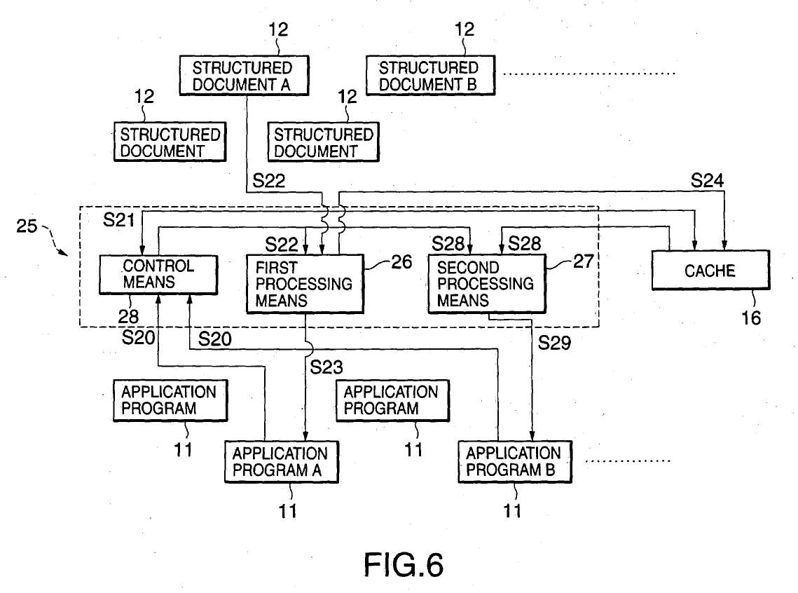

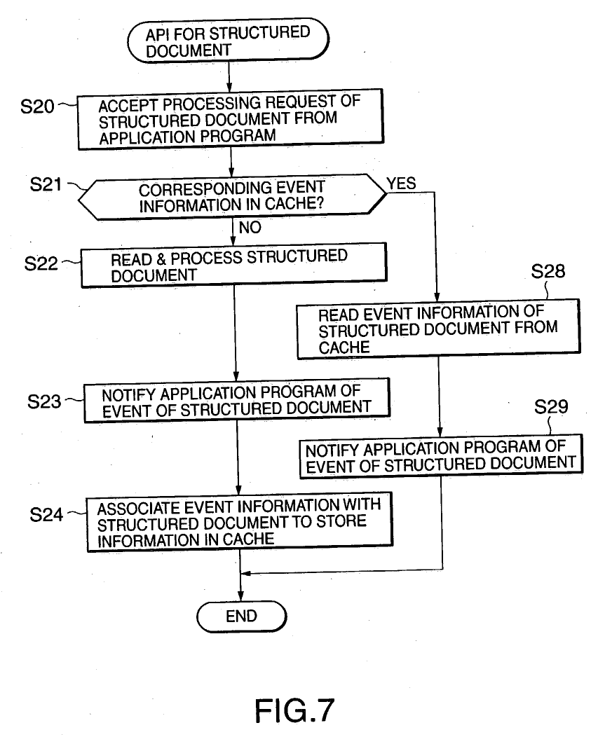

FIG. 6. is a function block diagram of the interface apparatus for the structured document 25 according to a third embodiment of the present invention. In FIG. 6, S20 to S29 correspond to steps S20 to S29 of FIG. 7 described later. For the interface apparatus for the structured document 25, the different respect from the interface apparatus for the structured document 20 will be described. The interface apparatus for the structured document 25 includes first processing means 26, second processing means 27, and control means 28. The control means 28 accepts the processing request concerning a certain structured document from the application program A (S20). It is assumed that the certain structured document will be referred to as the structured document A. The control means 28 checks whether or not the event set information on the structured document A is stored in the cache 16 (S21), and it is known that there is not the information. Then, the control means issues an instruction for the processing to the first processing means 26 (S22). The first processing means 26 reads the structured document A to perform the character code adjustment and lexical analysis (S22). It is seen that there is no error as a result of the lexical analysis concerning the structured document A. Then, the first processing means 26 notifies the application program A of the series of events concerning the structured document A in order (S23). The first processing means 26 also associates the series of notified events as the event set information with the structured document to store the information in the cache 16 (S24). Thereafter, the control means 28 accepts the processing request concerning the certain structured document from the application program B (the application program B may also be the application program A) (S20). The control means 28 checks presence/absence of the event set information on the structured document which has been requested to be processed from the application program (S21). When the certain structured document accepted in S20 is the structured document B different from the structured document A, the event set information on the structured document B is not in the cache 16, and therefore the control means 28 delegates the processing to the first processing means 26. When the certain structured document accepted in S20 is the structured document A, the event set information on the structured document A is in the cache 16, and therefore the control means 28 delegates the processing to the second processing means 27. The second processing means 27 reads the event set information relating to the structured document A from the cache 16 (S28), and notifies the application program B of the series of events relating to the structured document A in order based on the event set information (S29).

FIG. 7 is a flowchart of the processing procedure of the interface apparatus for the structured document 25 of FIG. 6. S20, S22 to S24 correspond to S1 to S4 of FIG. 3. S28, S29 correspond to S6, S7, of FIG. 3. In S20, the processing request concerning the certain structured document is accepted from the application program. In S21, it is checked whether or not there is the event set information relating to the certain structured document in the cache 16. If there is not, the procedure advances to S22. Moreover, if there is, the procedure advances to S28. In S22, the structured document which has been requested to be processed is read to perform the processing of the character code adjustment and lexical analysis. If there is not the error in the words and phrases, in S23 the application program which has issued the processing request in S20 is notified of the series of events relating to the structured document as the processing object. The series of events notified in S23 are stored as the event set information in the cache 16. In S28, the event set information relating to the structured document requested to be processed at this time is read from the cache 16. In S29, the series of events are notified to the application program which has issued the processing request in S20 in order based on the event set information read in S28. In the steps S28, S29, for the steps S22 to S24, the processing of the character code adjustment and lexical analysis is omitted, and therefore the notification of the series of events to the application program can be accelerated.

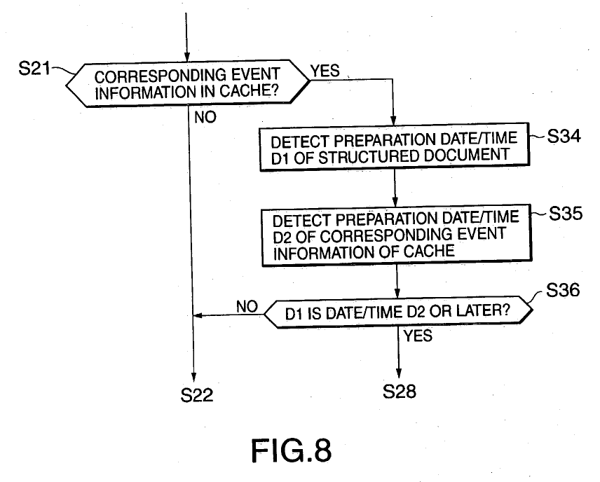

The above description with reference to FIGS. 6 and 7 is based on the assumption that the structured document including the event set information stored in the cache 16 is stored in the cache 16 with respect to the event set information and is not changed thereafter. When there is not a remaining amount sufficient for storing new event set information in the cache 16 because of a restriction on capacity of the cache 16, for example, the event set information is discarded in an old order of store date/time. In a period when the event set information concerning the certain structured document exists in the cache 16 without being discarded, the capacity may be limited. However, a source structured document is sometimes updated even in the existing period. Even when there is the event set information concerning the structured documents having the same file name in the cache 16, the update of the source structured document is not sometimes reflected. To handle this, it is checked whether or not the structured document as the basis of the event set information of the cache 16 is of the latest version. When the document is not of the latest version, the event set information in the cache 16 is not used with respect to the structured document. It is to be noted that the event set information found to be unusable is preferably immediately deleted from the cache 16. FIG. 8 is a flowchart of the processing procedure in which the event set information of the cache is used in handling the update of the structured document. In the flowchart of FIG. 8, S34 to S36 are added in addition to the judgment step of S21 of FIG. 7. In S21, it is judged whether or not there is the event set information relating to the structured document requested to be processed this time. In this judgment, it is simply judged whether or not there is the event set information relating to the structured document having the same file name X as that of the structured document requested to be processed this time. That is, in the judgment, the presence/absence of the update concerning the structured document which is the processing object is not judged. When the judgment of S21 results in NO, the processing goes to S22. When the judgment of S21 results in YES, the processing goes to S34. In S34, a preparation date/time D1 concerning a structured document original (source structured document) is detected. In a usual file system, management information such as the file preparation date/time is recorded in a predetermined storage area with respect to the file, and the preparation date/time D1 concerning the structured document original is detected by the access to the storage area. In S35, a preparation date/time D2 of the structured document which is the basis of the event set information concerning the file name X in the cache 16 is detected. In S36, it is judged whether or not D1 is the date/time of and after D2. That is, it is judged whether or not the structured document as the basis of the event set information concerning the file name x in the cache 16 is of the latest version. When the judgment results in YES, the processing goes to S28. If NO, the processing goes to S22. It is to be noted that here the updated information is confirmed using the date/time, but another method may also be used as long as the presence/absence of the update can be confirmed. When the source structured document is a local file, the preparation date/time of the document can be detected by detecting a time stamp. Moreover, when the source structured document is obtained by HTTP, the update state of the document can be detected based on a response to addition of header Last-Modified (there is not the update when the server response is 304, and there is the update when the response is 200).

The control means 28 is (a) mounted on the parser for the structured document such as an XML parser in some case, and (b) mounted in the application program in the other case. When the application program designates the structured document as the processing object into the interface apparatus for the structured document 25 with Uniform Resource Identifiers (URI, distinguished from URL described later). Since the parser for the structured document can URI, the parser itself can identify the structured document requested to be processed from the application program from the URI. Therefore, there is not any problem in case (a). On the other hand, for some application programs described in Java (trademark of Sun Microsystems, Inc. in the U.S. and other countries), the data is sometimes transferred to the parser for the structured document in a byte stream. That is, the application program opens the structured document which is the processing request object, and sometimes transfers the content of the opened structured document X to the parser for the structured document in the form of the byte stream. It is impossible to detect management information such as update date/time information from the byte stream, that is, the content itself of the structured document. When the parser for the structured document receives the data from the application program in the byte stream, the control means 28 cannot judge whether or not there is the event set information concerning the structured document as the processing object in the cache 16. To solve the problem, as in the case (b), the control means 28 is mounted in the application program. The control means 28 acquires necessary information on the structured document such as the preparation date/time, before the application program opens the structured document as the processing object. Subsequently, it is checked whether the event set information relating to the structured document X is in the cache 16 and whether the date/time of the structured document as the basis of the event set information is the same as that of the structured document original. Based on the result, it is determined that the processing is delegated to either the first processing means 26 or second processing means 27 of the parser for the structured document.

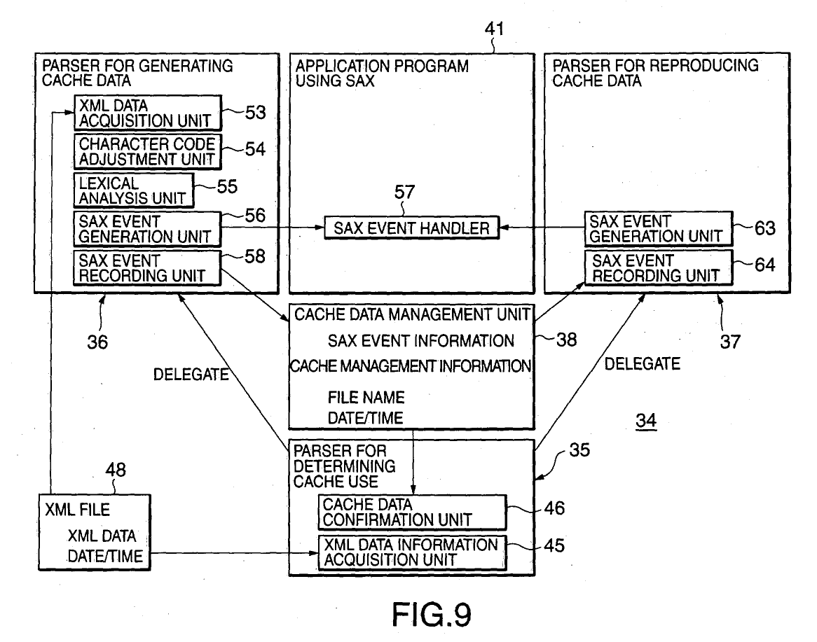

FIG. 9 is a constitution diagram of an SAX parser 34 which is the interface apparatus for the structured document. The SAX parser 34 includes a parser for determining cache use 35, parser for generating cache data 36, parser for reproducing cache data 37, and cache data management unit 38. The SAX parser 34 and application program 41 are typically mounted on a server and client connected to each other via LAN, intranet, or internet. However, the SAX parser 34 and application program 41 are sometimes mounted in the same computer. The application program 41 designates a predetermined XML file 48 with the path name and URL, and requests the SAX parser 34 to process the XML file 48. An XML data information acquisition unit 45 of the SAX parser 34 reads the XML file 48 which has been requested to be processed from the application program 41. It is to be noted that the path name is designated to read the file by the XML data information acquisition unit 45, when the XML file 48 is in the computer including the SAX parser 34, that is, the local file. However, when the XML file 48 is stored in the server connected to the computer including the SAX parser 34 via the internet or intranet, URL is designated by http or http secured (https) to read the file.

The contents of the XML file 48 are illustrated as

follows:

[Content Example of XML File 48]

<?xml version=″1.0″ encoding=″Shift_JIS″?>
<!DOCTYPE GUIDef SYSTEM ″GUIDef.dtd″>
<GUIDef>

<Parts name=″DirTree″ class=″editor.DirTree″

vp=″FileAsString″ />

<Window name=″Main″ clear=″true″>

<Layout class=″java.awt BorderLayout″ />
<Group name=″tab″ parts=″Tab″ pos=″Center″>

<Ctrl parts=″Label″ pos=″North″>

<Init>new preparation of project</Init>

</Ctrl>

</Group>
<Event action=″Cleaner″ />
<Pr name=″Title″>selection of project</Pr>

</ Window>

</GUIDef>

On the other hand, a cache data confirmation unit 46 of the parser for determining cache use 35 uses the cache data management unit 38 to search the cache for SAX event set information. In the cache managed by the cache data management unit 38, the SAX event set information can be stored with respect to several application programs 41 in the capacity of the cache. When new SAX event set information is to be stored in the cache, and when the store capacity is not left in the cache, an appropriate number of pieces of old SAX event set information are appropriately deleted. The capacity for storing the new SAX event set information is secured, and the new SAX event set information is stored in the capacity. The information of the preparation date/time of each XML file 48 is recorded, for example, as the time stamp, and the last update date/time can be known as the preparation date/time of the XML file 48 from the time stamp of the XML file 48 of the source. The cache data confirmation unit 46 searches the SAX event set information associated with the XML file 48 having the same file name as that of the XML file 48 to be processed by the parser for determining cache use 35 requested from the application program 41 this time, and confirms the date/time of the searched SAX event set information. The parser for determining cache use 35 collates the preparation date/time of the existing XML file 48 read by the XML data information acquisition unit 45 with the date/time of the SAX event set information confirmed by the cache data confirmation unit 46. It is checked whether or not the SAX event set information in the cache is the SAX event set information based on the content of the existing structured document. (a) When there is not the SAX event set information on the XML document having the same file name in the cache with respect to the XML file 48 requested to be processed from the application program 41 this time, or (b) when there is the SAX event set information on the XML document having the same file name in the cache with respect to the XML file 48 requested to be processed from the application program 41 this time but when the preparation date/time of the XML file 48 as the basis of the SAX event set information is older than that of the existing XML file 48, the parser for determining cache use 35 judges that the SAX event set information of the cache is unusable. The subsequent processing of the XML file 48 which is the processing request object is delegated to the parser for generating cache data 36. On the other hand, (c) when the SAX event set information on the XML document having the same file name is in the cache with respect to the XML file 48 requested to be processed from the application program 41 this time, and when the preparation date/time of the XML file 48 as the basis of the SAX event set information is not older than that of the existing XML file 48, that is, when the XML file 48 is not updated, the parser for determining cache use 35 judges that the SAX event set information of the cache is unusable. The subsequent processing of the XML file 48 which is the processing request object is delegated to the parser for reproducing cache data 37.

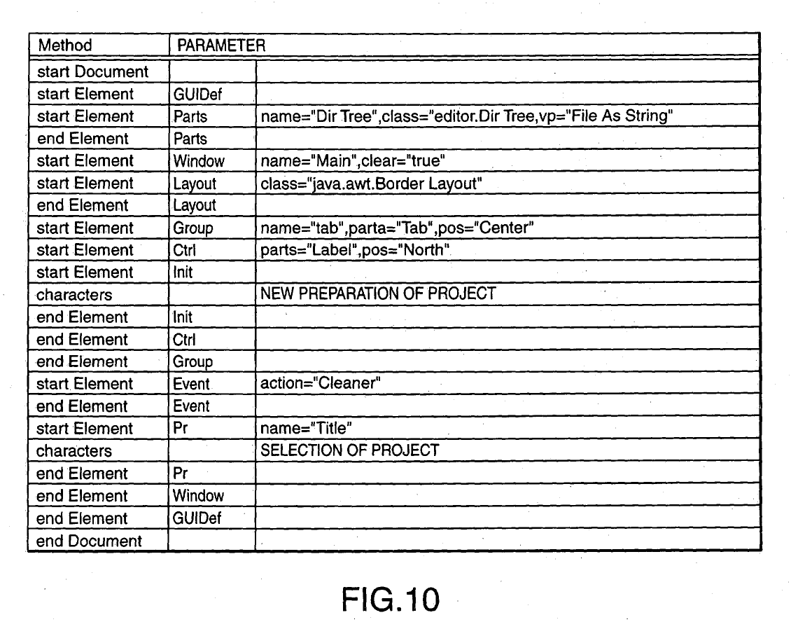

The parser for generating the cache data 36 includes an XML data acquisition unit 53, character code adjustment unit 54, lexical analysis unit 55, SAX event generation unit 56, and SAX event recording unit 58. When the processing is delegated to the parser for generating cache data 36 from the parser for determining cache use 35, the XML data acquisition unit 53 reads the XML file 48 as the processing object, and acquires the XML data of the XML file 48. The character code adjustment unit 54 converts the character code (e.g., Shift JIS) of the XML data read by the XML data acquisition unit 53 to Unicode. The lexical analysis unit 55 performs the lexical analysis of the XML file 48 as the processing object based on Unicode of the XML file 48. When the lexical analysis unit 55 judges that there is not the error in the lexical analysis of the XML file 48, the SAX event generation unit 56 shifts to processing of generating the series of events relating to the XML file 48. The application program 41 which has requested for the processing of the XML file 48 this time are notified of the series of events in order via a SAX event handler 57. When there is the error, the application program 41 is not notified of the series of events, and is notified that there is the error. FIG. 10 shows a SAX event notified to the application program 41 by the SAX event generation unit 56. The notification of the series of events to the application program 41 from the SAX event generation unit 56 via the SAX event handler 57 is performed via Method of Object Oriented Program (OOP) mounted in the SAX event generation unit 56. One or more parameters (arguments) are attached to a certain type of method, and the parameter includes an element name (e.g., GUIDef, Parts) of the XML file 48, and attribute name (e.g., name, class, vp)=attribute value (e.g., “Dirtree”, “editor.DirTree”). To execute the method, the SAX event generation units 56, 63 need to include various types of interfaces. Examples of the interfaces to be mounted in the SAX event generation units 56, 63 are defined, for example, in class org.xml.sax.DocumentHandler as follows.

public abstract void setDocumentLocator (Locator locator);

public abstract void startDocument ( )

public abstract void enddocument ( )

public abstract void startElement (String name, AttributeList atts)

public abstract void endElement (String name)

public abstract void characters (char ch[], int start, int length)

public abstract void ignorableWhitespace (char ch[], int start, mnt length)

public abstract void processing instruction (String target, String data)

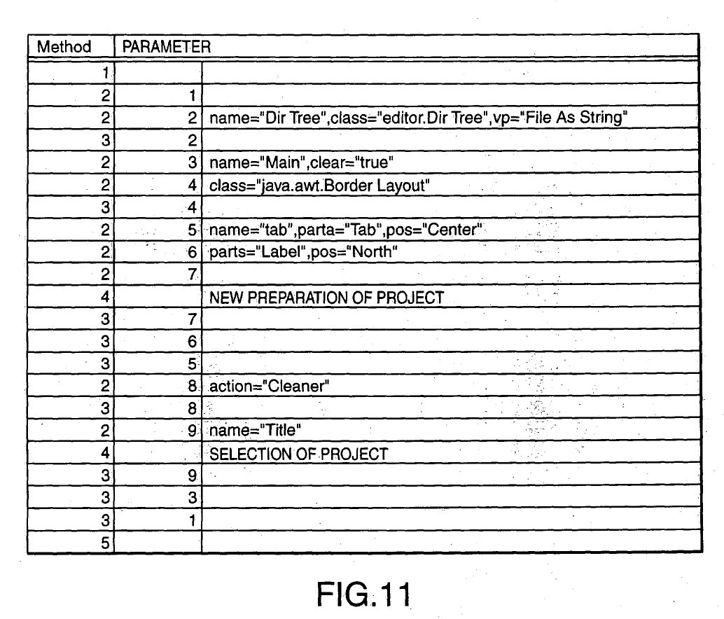

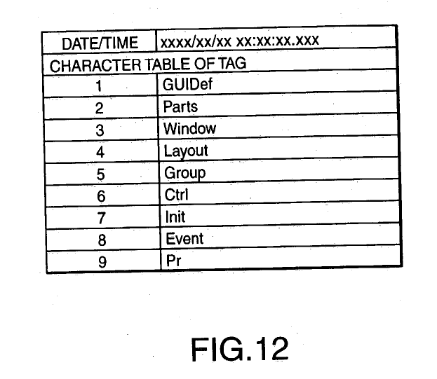

The SAX event recording unit 58 records the series of events notified to the application program 41 from the SAX event generation unit 56 as the SAX event set information in the cache via the cache data management unit 38. The SAX event set information needs to include preparation date/time information of the XML file 48 which is the basis of the SAX event set information in order to check the update of the XML file 48. FIGS. 11 and 12 show first and second parts of the SAX event set information recorded in the cache. The method and parameter are described in each record in the first part of the SAX event set information. The parameter includes the element name and attribute. The method and element names are coded. A correspondence between the element name and code is described in the second part. For the method, a relation between the code and method name is as follows. A relation between the code and method name with respect to the method is defined regardless of the XML file 48.

startDocument: 1

startElement: 2

endElement: 3

characters: 4

enddocument: 5

In the second part of FIG. 12, the preparation date/time of the XML document which is the basis of the SAX event set information is recorded in a first record of a table. A relation between the code and tag (element name) is recorded with respect to the element of the XML file 48 in second and subsequent records of the table. A relation between the code and tag (element name) is defined with respect to the element of the XML file 48 for each XML file 48. In the above-described update check of the XML file 48 in the parser for determining cache use 35, the preparation date/time of the existing XML file 48 is collated with the preparation date/time of the first record of FIG. 12.

The parser for reproducing the cache data 37 includes a SAX event generation unit 63 and SAX event reproduction unit 64. When the processing of the XML file 48 as the processing object is delegated to the parser for reproducing cache data 37 from the parser for determining cache use 35, the SAX event reproduction unit 64 instructs the cache data management unit 38 to send the SAX event set information in the structured document to the reproduction unit, and reproduces a series of SAX events (in other words, for example, the respective events of the series of SAX events are associated in order and detected). The SAX event set information received from the cache data management unit 38 by the SAX event reproduction unit 64 is shown in FIGS. 11 and 12. The SAX event reproduction unit 64 converts the element code of FIG. 11 into the element name, reproduces the list of FIG. 10, and transfers the list to the SAX event generation unit 63 based on the relation between the code and tag (element name) with respect to the element of the XML file 48 in FIG. 12. Based on the list, the SAX event generation unit 63 executes the respective methods in order from the top of the list of FIG. 11, and the series of events are notified to the application program 41 via the SAX event handler 57.

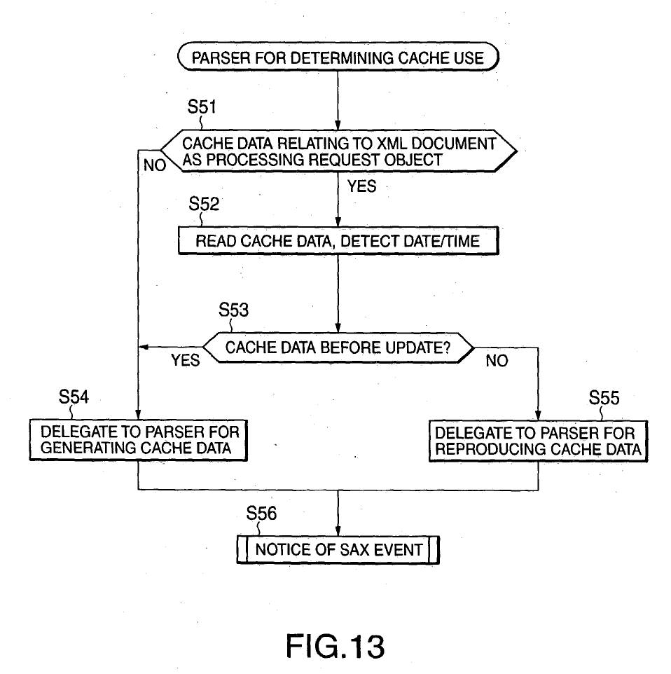

FIG. 13 is a flowchart of the processing procedure of the parser for determining cache use 35 of FIG. 9. In S51, it is checked whether or not there is the cache data (=SAX event set information in the cache) relating to the XML file 48 requested to be processed by the application program 41 this time. That is, it is judged whether or not there is the cache data associated with the file name of the XML file 48. When the judgment results in YES, the processing goes to S52. If NO, the processing goes to S54. In the judgment of S51, update situation of the XML file 48 is not checked. It is checked only whether or not there is the cache data relating to the XML file having the same file name as that of the XML file 48 as the processing object in the cache. In S52, the cache data relating to the XML file 48 which is the processing object is read. That is, the data of FIG. 12 is read. The date/time of the data, that is, the preparation date/time of the XML file 48 which is the basis of the SAX event set information in the cache is detected. In S53, it is checked whether or not the cache data in the cache is the data based on the XML document before the update of the existing XML file 48. When the judgment in S53 results in YES, that is, when the XML document as the basis of the SAX event set information in the cache has not been updated yet, the processing goes to S54 when the judgment in S53 results in NO, that is, when the XML document as the basis of the SAX event set information in the cache is the existing XML document, the processing goes to S55. The processing of the XML file 48 which is the processing object is delegated to the parser for generating cache data 36 in S54, and delegated to the parser for reproducing cache data 37 in S55.

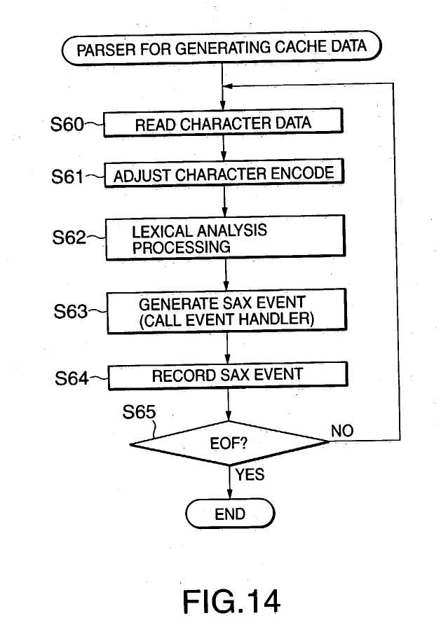

FIG. 14 is a flowchart of the processing procedure of the parser for generating the cache data 36 of FIG. 9. In S60, character data of the XML file 48 which is the processing object is read. In S61, the character data read in S60 is converted to Unicode. The character code of the Japanese XML document conforms, for example, to Sift JIS. In S62, the lexical analysis processing is performed. In S63, on finding the tag of element name definition in the XML file 48 which is the processing object, one SAX event corresponding to the element name is generated. The corresponding method is used to call the event handler and notify the application program 41 of the generated SAX event. In S65, it is judged whether or not the end (EOF) of the XML file 48 is reached. When the judgment results in YES, the processing procedure is ended. If NO, the processing returns to S60 to read the next character data.

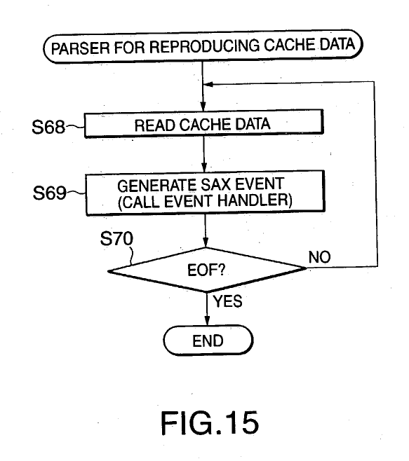

FIG. 15 is a flowchart of the processing procedure of the parser for reproducing cache data 37 of FIG. 9. In S68, a predetermined part of the cache data which is the SAX event set information relating to the XML file 48 as the processing object is read from the cache. In S69, the SAX event is generated based on the predetermined part of the cache data read in S68. The corresponding method is used to call the event handler so that the generated SAX event is notified to the application program 41. In S70, it is judged whether or not the end (EOF) of the SAX event set information (FIG. 12) is reached. When the judgment results in YES, the processing procedure ends. If NO, the processing returns to S68.

The description of the present invention has been presented for purposes of illustration and description, but is not intended to be exhaustive or limited to the form disclosed. Many modifications and variations will be apparent to those of ordinary skill in the art.

What is claimed:

1. An interface apparatus for a structured document, for performing processing of lexical analysis and processing of notifying an application program of a processing requester of a series of events relating to the structured document in order with respect to the structured document requested to be processed from the application program, the apparatus comprising:
store means for associating the series of events notified to the application program as event set information with the structured document to store the information into a cache; and
first notification means for notifying the application program as the processing requester of the series of events relating to the structured document in order based on the event set information of the cache, when there is the event set information in the cache with respect to the structured document as a processing object.

2. The interface apparatus for the structured document according to claim 1, further comprising:
second notification means for reading the structured document whose event set information is not in the cache to perform the processing of the lexical analysis and the processing of notifying the application program as the processing requester of the series of events relating to the structured document in order,
wherein the store means associates the series of events notified to the application program by the second notification means as the event set information with the structured document to store the information into the cache.

3. An interface apparatus for a structured document, comprising:
first processing means for reading the structured document as a processing request object to perform the processing of the lexical analysis, the processing of notifying the application program as the processing requester of the series of events relating to the structured document in order, and the processing of associating the notified series of events as the event set information with the structured document to store the information into the cache;
second processing means for reading the event set information of the cache with respect to the structured document as the processing request object to notify the application program as the processing requester of the series of events relating to the event set information in order; and
control means for checking whether or not the event set information of the structured document as the processing object is in the cache to delegate the processing concerning the structured document as the processing object to the first processing means, when there is not the event set information in the cache, or to delegate the processing concerning the structured document as the processing object to the second processing means, when there is the event set information in the cache.

4. The interface apparatus for the structured document according to claim 3, wherein the control means judges presence/absence of the event set information of the structured document as the processing object in the cache, and judges that there is not the event set information in the cache with respect to the structured document as the processing object, when the event set information relating to a structured document having the same file name as that of the structured document as the processing object exists in the cache but when the event set information relates to a structured document before update of the existing structured document.

5. The interface apparatus for the structured document according to claim 4, wherein the control means is a parser notified from the application program of the processing requester of the structured document of the processing request object by URI.

6. The interface apparatus for the structured document according to claim 4, wherein the first and second processing means are mounted in corresponding parsers, whereas the control means is mounted in the application program as the processing requester.

7. A processing method for a structured document, for performing processing of lexical analysis and processing of notifying an application program as a processing requester of a series of events relating to the structured document in order with respect to the structured document requested to be processed from the application program, the method comprising:
a first step of associating the series of events notified to the application program as event set information with the structured document to store the information into a cache; and
a second step of notifying the application program as the processing requester of the series of events relating to the structured document in order based on the event set information of the cache, when there is the event set information in the cache with respect to the structured document as a processing object.

8. The processing method for the structured document according to claim 7, further comprising:
a third step of reading the structured document whose event set information is not in the cache to perform the processing of the lexical analysis and the processing of notifying the application program as the processing requester of the series of events relating to the structured document in order, and
a fourth step of associating the series of events notified to the application program as the event set information with the structured document to store the information into the cache in the third step.

9. A processing method for a structured document, comprising:
a step for standard processing of reading the structured document as a processing request object to perform processing of lexical analysis, processing of notifying an application program as a processing requester of a series of events relating to the structured document in order, and processing of associating the notified series of events as event set information with the structured document to store the information into a cache;
a step for reduction processing of reading the event set information of the cache with respect to the structured document as the processing request object to notify the application program as the processing requester of the series of events relating to the event set information in order; and
a control step of checking whether or not the event set information of the structured document as the processing object is in the cache, and controlling the step for the standard processing so as to be executed, when there is not the event set information in the cache, or controlling the step for the reduction processing so as to be executed, when there is the event set information in the cache.

10. The processing method for the structured document according to claim 9, wherein the control step comprises: judging that there is not the event set information in the cache with respect to the structured document as the processing object, when it is judging whether or not there is the event set information of the structured document as the processing object in the cache and when the event set information relating to a structured document having the same file name as that of the structured document as the processing object exists in the cache but when the event set information relates to a structured document before update of the existing structured document.

11. The processing method for the structured document according to claim 10, wherein the control step is performed in a parser notified from the application program of the processing requester for the structured document of the processing request object by URI.

12. The processing method for the structured document according to claim 10, wherein the first and second processing steps are performed in corresponding parsers, whereas the control step is performed in the application program issuing the processing request with respect to the structured document.

13. A processing program product for a structured document, for performing processing of lexical analysis and processing of notifying an application program as a processing requester of a series of events relating to the structured document in order with respect to the structured document which has been requested to be processed from the application program, the program allowing a computer to execute:
a first step of associating the series of events notified to the application program as event set information with the structured document to store the information into a cache; and
a second step of notifying the application program as the processing requester of the series of events relating to the structured document in order based on the event set information of the cache, when there is the event set information in the cache with respect to the structured document as a processing object.

14. The processing program product for the structured document according to claim 13, further allowing the computer to execute:
a third step of reading the structured document whose event set information is not in the cache to perform the processing of the lexical analysis and the processing of notifying the application program as the processing requester of the series of events relating to the structured document in order; and
a fourth step of associating the series of events notified to the application program as the event set information with the structured document to store the information into the cache in the third step.

15. A processing program product for a structured document, for allowing a computer to execute:
a step for standard processing of reading a structured document of a processing request object to perform processing of lexical analysis, processing of notifying an application program as a processing requester of a series of events relating to the structured document in order, and processing of associating the notified series of events as event set information with the structured document to store the information into a cache;
a step for reduction processing of reading the event set information of the cache with respect to the structured document as the processing request object to notify the application program as the processing requester of the series of events relating to the event set information in order; and
a control step of checking whether or not the event set information on the structured document as the processing object is in the cache, and controlling the step for the standard processing so as to be executed, when there is not the event set information in the cache, or controlling the step for the reduction processing so as to be executed, when there is the event set information in the cache.

16. The processing program product for the structured document according to claim 15, wherein the control step allows the computer to execute a step of judging that there is not the event set information in the cache with respect to the structured document as the processing object, when it is judged whether or not there is the event set information on the structured document as the processing object in the cache and when the event set information relating to a structured document having the same file name as that of the structured document as the processing object exists in the cache but when the event set information relates to a structured document before update of the existing structured document.

17. The processing program product for the structured document according to claim 16, allowing the computer to execute the control step in a parser notified from the application program as the processing requester for the structured document as the processing request object by URI.

18. The processing program product for the structured document according to claim 16, allowing the computer to execute the first and second processing steps in corresponding parsers, and the control step in the application program issuing the processing request with respect to the structured document.
